(19) United States
(12) Patent Application Publication
(10) Pub. No.: US 2016/0247231 A1
(43) Pub. Date: Aug. 25, 2016

(54) SYSTEM FOR ASSESSING IMPACT OF FINANCIAL EVENTS ON RETIREMENT PLANNING

(71) Applicant: BANK OF AMERICA CORPORATION, Charlotte, NC (US)

(72) Inventors: Jeanne Ferullo Connolly, Braintree, MA (US); Katherine Dintenfass, Charlotte, NC (US); Matthew Hsieh, Charlotte, NC (US); Carrie Anne Hanson, Charlotte, NC (US); Dariane Katinka Hunt, Concord, MA (US)

(21) Appl. No.: 14/626,810

(22) Filed: Feb. 19, 2015

(51) Int. Cl. G06Q 40/06

(52) U.S. Cl. CPC G06Q 40/06

(57) ABSTRACT

Embodiments of the invention are directed to systems, methods, and computer program products for assessing impact of financial events on retirement planning. The system is configured to receive information associated with financial institution accounts of the user; initiate presentation of a spend user interface to the user, wherein the spend user interface comprises at least selectable financial event options for the one or more financial events that could occur for the user; receive, via the spend user interface, a user selection of a financial event from the one or more financial events; determine one or more payment options from the financial institution accounts for the financial event selected by the user; and calculate a new amount of spendable funds or a new estimated amount of time associated with an availability of the amount of funds available in the financial institution accounts.

### FIELD

In general, embodiments of the invention relate to retirement planning, in particular, embodiments of the invention relate to a framework to provide an assessment of the impact that certain financial events may have on retirement planning.

### BACKGROUND

Retirement planning, in a financial context, refers to the allocation of savings or revenue for retirement in an attempt to achieve financial independence, so that the need to be gainfully employed is optional rather than a necessity. Most retirement planning models provide a target sum that the user should save before retirement, but fail to consider other costs that may change retirement planning over time.

### BRIEF SUMMARY

Embodiments of the present invention address the above needs and/or achieve other advantages by providing apparatuses (e.g., a system, computer program product, and/or other device) and methods for a system to assess impact of financial events on retirement planning. The present invention enables a user to plan for specific financial events, planned or otherwise, and incorporate the corresponding expenses into retirement planning. In this regard, the user may be able to select one or more events and customize the event to determine the effect of the one or more events on user's current financial situation. In doing so, the user may keep track of the retirement scenario specifics in real-time as and when the one or more events unfold.

In some embodiments, a system for assessing impact of financial events on retirement planning for a user is presented. The system comprises at least one non-transitory storage device; at least one processor; and at least one module stored in said storage device and comprising instruction code that is executable by the at least one processor and configured to cause said at least one processor to: receive information associated with financial institution accounts of the user from a distributed network of servers, wherein the information comprises an amount of funds associated with the user's assets, an amount of outgoing funds of the user, and an amount of incoming funds of the user; calculate an amount of spendable funds associated with the user for a time period, wherein the amount of spendable funds is calculated based on the amount of funds associated with the user's assets, the amount of outgoing funds, and the amount of incoming funds for the time period; calculate an estimated amount of time associated with an availability of the amount of funds associated with the user's assets based on at least the amount of spendable funds and the amount of funds associated with the user's assets; initiate presentation of a spend user interface to the user, wherein the spend user interface is provided on a user device and comprises at least the amount of spendable funds associated with the user, the estimated amount of time associated with the availability of the amount of funds associated with the user's assets, and selectable financial event options for one or more financial events, wherein the selectable options comprise the one or more financial events that could occur for the user; receive, via the spend user interface, a user selection of a financial event from the one or more financial events; initiate presentation of an event information user interface to the user, wherein the event information user interface is provided on the user device and comprises at least selectable options associated with the financial event selected by the user and enables the user to input financial event information associated with the financial event selected by the user; receive, via the event information user interface, the financial event information associated with the financial event selected by the user; access the distributed network of servers to determine financial event costs based on the financial event information; determine one or more payment options from the financial institution accounts for the financial event selected by the user based on at least the amount of funds associated with the user's assets; initiate presentation of a payment option user interface to the user, wherein the payment option user interface is provided on the user device and comprises the one or more payment options for the financial event; receive, via the payment option user interface, at least one of the one or more payment options based on at least a user selection of the one or more payment options; calculate a new amount of spendable funds or a new estimated amount of time associated with an availability of the amount of funds associated with the user's assets; and initiate presentation of an updated spend user interface to the user, wherein the updated spend user interface is provided on the user device and comprises the new amount of spendable funds or the new estimated amount of time, one or more of the financial institution accounts used to cover the one or more payment options, and an amount from one or more of the financial institution accounts.

In some embodiments, the module is further configured to cause a processor to determine whether the user is at least one of ahead of a plan, on plan, or behind plan based on at least the amount of outgoing funds, the amount of incoming funds, and the amount of spendable funds; wherein the user is ahead of a plan when the combination of the amount of outgoing funds and the amount of spendable funds is less than the amount incoming funds; wherein the user is on plan when the combination of the amount of outgoing funds and the amount of spendable funds is equal to the amount of incoming funds; and wherein the user is behind plan when the combination of the amount of outgoing funds and the amount of spendable funds is greater than the amount of incoming funds.

In some embodiments, the module is further configured to cause a processor to: receive a user input related to the estimated amount of time associated with an availability of the amount of funds associated with the user's assets; and calculate a new amount of spendable funds based on at least the received estimated amount of time associated with the availability of funds associated with the user's assets.

In some embodiments, the module is further configured to cause a processor to: receive a user input related to the amount of spendable funds; and calculate a new estimated amount of time associated with an availability of the amount of funds associated with the user's assets based on at least the received amount of spendable funds.

In some embodiments, the module is further configured to cause a processor to: receive a user input to customize a financial institution event that could occur for the user; receive event information associated with the customizable financial institution event that could occur for the user; access the distributed network of servers to determine the customized financial event costs based on the customized financial event information, or receive a cost input from the user; and determine one or more payment options from the financial institution accounts for the customized financial event selected by the user based on at least the amount of funds associated with the user's assets, rates of return of the financial accounts, and minimizing any penalties associated with using the funds associated with the user's assets.

In some embodiments, the module is further configured to cause a processor to: determine a payment disbursement plan to enable the user to pay for the one or more financial events, wherein the disbursement plan comprises a percentage allocation of amounts from the one or more financial institution accounts of the user to be applied towards the one or more financial events selected by the user; receive a user confirmation to execute the determined the payment disbursement plan; and execute the payment disbursement plan.

In some embodiments, the module is further configured to cause a processor to: enable the user to adjust the percentage allocation of the amount from the one or more financial institution accounts of the user, wherein adjusting further comprises adjusting a current weight of one or more holdings associated with the one or more financial institution accounts of the user.

In some embodiments, a computer implemented method for assessing impact of financial events on retirement planning for a user is presented. The method comprises receiving, using a computing device processor, information associated with financial institution accounts of the user from a distributed network of servers, wherein the information comprises an amount of funds associated with the user's assets, an amount of outgoing funds of the user, and an amount of incoming funds of the user; calculating, using a computing device processor, an amount of spendable funds associated with the user for a time period, wherein the amount of spendable funds is calculated based on the amount of funds associated with the user's assets, the amount of outgoing funds, and the amount of incoming funds for the time period; calculating, using a computing device processor, an estimated amount of time associated with an availability of the amount of funds associated with the user's assets based on at least the amount of spendable funds and the amount of funds associated with the user's assets; initiating, using a computing device processor, presentation of a spend user interface to the user, wherein the spend user interface is provided on a user device and comprises at least the amount of spendable funds associated with the user, the estimated amount of time associated with the availability of the amount of funds associated with the user's assets, and selectable financial event options for one or more financial events, wherein the selectable options comprise the one or more financial events that could occur for the user; receiving, via the spend user interface, a user selection of a financial event from the one or more financial events; initiating, using a computing device processor, presentation of an event information user interface to the user, wherein the event information user interface is provided on the user device and comprises at least selectable options associated with the financial event selected by the user and enables the user to input financial event information associated with the financial event selected by the user; receiving, via the event information user interface, the financial event information associated with the financial event selected by the user; accessing, using a computing device processor, the distributed network of servers to determine financial event costs based on the financial event information; determining, using a computing device processor, one or more payment options from the financial institution accounts for the financial event selected by the user based on at least the amount of funds associated with the user's assets; initiating, using a computing device processor, presentation of a payment option user interface to the user, wherein the payment option user interface is provided on the user device and comprises the one or more payment options for the financial event; receiving, via the payment option user interface, at least one of the one or more payment options based on at least a user selection of the one or more payment options; calculating, using a computing device processor, a new amount of spendable funds or a new estimated amount of time associated with an availability of the amount of funds associated with the user's assets; and initiating, using a computing device processor, presentation of an updated spend user interface to the user, wherein the updated spend user interface is provided on the user device and comprises the new amount of spendable funds or the new estimated amount of time, one or more of the financial institution accounts used to cover the one or more payment options, and an amount from one or more of the financial institution accounts.

In some other embodiments, a computer program product for assessing impact of financial events on retirement planning for a user is presented. The computer program product comprises a non-transitory computer-readable medium comprising code causing a first apparatus to receive information associated with financial institution accounts of the user from a distributed network of servers, wherein the information comprises an amount of funds associated with the user's assets, an amount of outgoing funds of the user, and an amount of incoming funds of the user; calculate an amount of spendable funds associated with the user for a time period, wherein the amount of spendable funds is calculated based on the amount of funds associated with the user's assets, the amount of outgoing funds, and the amount of incoming funds for the time period; calculate an estimated amount of time associated with an availability of the amount of funds associated with the user's assets based on at least the amount of spendable funds and the amount of funds associated with the user's assets; initiate presentation of a spend user interface to the user, wherein the spend user interface is provided on a user device and comprises at least the amount of spendable funds associated with the user, the estimated amount of time associated with the availability of the amount of funds associated with the user's assets, and selectable financial event options for one or more financial events, wherein the selectable options comprise the one or more financial events that could occur for the user; receive, via the spend user interface, a user selection of a financial event from the one or more financial events; initiate presentation of an event information user interface to the user, wherein the event information user interface is provided on the user device and comprises at least selectable options associated with the financial event selected by the user and enables the user to input financial event information associated with the financial event selected by the user; receive, via the event information user interface, the financial event information associated with the financial event selected by the user; access the distributed network of servers to determine financial event costs based on the financial event information; determine one or more payment options from the financial institution accounts for the financial event selected by the user based on at least the amount of funds associated with the user's assets; initiate presentation of a payment option user interface to the user, wherein the payment option user interface is provided on the user device and comprises the one or more payment options for the financial event; receive, via the payment option user interface, at least one of the one or more payment options based on at least a user selection of the one or more payment options; calculate a new amount of spendable funds or a new estimated amount of time associated with an availability of the amount of funds associated with the user's assets; and initiate presentation of an updated spend user interface to the user, wherein the updated spend user interface is provided on the user device and comprises the new amount of spendable funds or the new estimated amount of time, one or more of the financial institution accounts used to cover the one or more payment options, and an amount from one or more of the financial institution accounts.

### BRIEF DESCRIPTION OF THE DRAWINGS

Having thus described embodiments of the invention in general terms, reference will be made to the accompanying drawings, where:

FIG. 1A illustrates a high level process flow for retirement planning based on fund distributions, in accordance with one embodiment of the present invention;

FIG. 1B illustrates a flow indicating how the available fund amount and/or an age parameter are influenced, in accordance with one embodiment of the invention;

FIG. 2A presents a high level process flow for a system for assessing impact of financial events on retirement planning in accordance with an embodiment of an invention;

FIG. 2B illustrates a high level process flow for assessing impact of financial events on retirement planning at a predetermined future date in accordance with an embodiment of an invention;

FIG. 3 presents an exemplary block diagram of the system environment in accordance with embodiments of the invention;

FIG. 4 illustrates an exemplary spend user interface in accordance with an embodiment of an invention;

FIG. 5 illustrates an exemplary event information user interface in accordance with an embodiment of an invention;

FIG. 6 illustrates an exemplary payment option user interface in accordance with an embodiment of an invention;

FIG. 7 illustrates an exemplary event scheduling interface in accordance with an embodiment of an invention; and

FIG. 8 illustrates an exemplary updated spend user interface in accordance with an embodiment of an invention.

### DETAILED DESCRIPTION OF THE INVENTION

### Glossary of Terms

The following glossary of terms is intended to define the terms solely as they relate to this patent document, and should not be interpreted as definitions of the terms in any other context.

### Account

An “account” is the relationship that a user has with an entity, such as a financial institution. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity.

### Age Parameter

The “age parameter” refers to an estimated age at which the user will not be able to cover the user's outflows (estimated amount of time associated with the amount of available funds based on the user assets, including the user financial accounts). The age parameter is based on the user's assets, liabilities, estimated inflows, estimated outflows, rates of return and interest on assets and liabilities. Stated another way, the age at which the user's outflows are greater than the user's inflows and the user has no additional assets to cover the difference.

### Assets

“Assets” include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like.

### Authentication Information

“Authentication information” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system.

### Available Balance or Funds

“Funds” or “Available Balance” are a balance in an account that can be invested or withdrawn. For example, the funds may refer to a bank ledger balance minus the amount of any monetary checks in the process of collection. Funds may also be referred to as an available balance, a collected balance, good funds, and usable funds.

### Available Fund Amount or Amount of Spendable Funds

The “available fund amount” or “amount of spendable funds” is the amount of money a user can spend above the user's cost of living expenses (e.g., essential or semi-essential expenses) for entertainment, vacations, gifts, or other like non-essential expenses (e.g., fun money, safe to spend amount, or the like) while maintaining enough funds to reach a certain age (e.g., age parameter at which the user's funds will be depleted and will no longer be able to cover the outflows). For example, the amount of funds left over after the difference between the in-flows and out-flows are determined.

### Bank Account or Financial Account

A “bank account” is a financial account between a bank customer and a financial institution. Examples of bank accounts include a deposit account, such as a transactional account (e.g., a banking account), a savings account, an investment account, a money market account, a time deposit, a demand deposit, a pre-paid account, a credit account, or the like.

### Checking Account

A “checking account” is a deposit account held at a bank or other financial institution for the purpose of securely and quickly providing access to funds on demand, through a variety of different channels.

### Communication Interface

A “communication interface” or “communication device” is any device for communicating with other devices or with one or more users. For example, a communication interface may include a modem, server, transceiver, and/or a user interface.

### Computer Program Product

A “computer program product” is an article of manufacture that includes any non-transitory computer readable storage medium having data, code, or other information stored thereon. A computer program product typically includes computer-executable instructions (e.g., code) stored on non-volatile memory. When executed by a processor, such computer-executable instructions typically cause the processor to perform one or more functions.

### Computing Device

A “computing device” is any device that employs a processor and memory and can perform computing functions, such as a personal computer or a mobile device.

### Database

A “database” or “data warehouse” is a computer based storage location composed of data extracted from data processing systems.

### Demand Deposit Account

A “demand deposit account” is a bank account from which deposited funds can be withdrawn on demand without advance notice to the depository institution, such as, for example, general checking and saving accounts.

### Discount

A “discount” is the amount by which the price for a product/service is less than its par or face value of the product/service.

### Entity

An “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity.

### Financial Institution

A “financial institution” is any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like.

### Financial Event or Life Event

A “financial event” or “life event” may be any immediate or future event that causes a change in a user's financial status. A financial event may be a charge, a transaction, and exchange, or the like that may cause the user to lose or gain money and/or assets. Examples of financial events or life events include a medical expense, buying a house, college tuition, rent, and the like.

### Financial Transaction

A “financial transaction” refers to any transaction involving a transfer of money or something of monetary value. For example, a financial transaction may refer to a purchase of goods or services, a return of goods or services, a payment transaction, a credit transaction, a rewards transfer, or an account money transfer or withdrawal.

### Inflow of Funds, Inflows, Incoming Funds

Refers to funds received from or deposited into the user's assets (e.g., user's accounts, or the like), such as paychecks, 401K disbursements, pension disbursements, rental property, or the like.

### Interest

“Interest” is the monetary benefit paid by a borrower for the right to use a lender's or a depositor's funds. In one example, interest may be periodically paid over the life of a loan, deposit, security, or the like. In another example, some interest-bearing instruments, such as savings accounts, may not have defined maturities such that interest is not paid periodically over the life of the instrument but instead is paid solely at the end of the loan/deposit/security term.

### Line of Credit

A “line of credit” is (1) a type of loan that permits a borrower to draw funds, up to a specified maximum, for a defined period of time, or (2) any loan that permits the borrower to borrow funds up to a specified maximum, make repayments in any amount at any time, and obtain any number of advances so long as the maximum is not exceeded. For example, a customer may be issued a revolving line of credit such that the amount borrowed from the line of credit can be paid down and borrowed/advanced again, as the customer's needs change.

### Liabilities

“Liabilities” are cash or cash equivalent debt that a user may owe to an entity. Examples of liabilities may include a home mortgage, another type of loan for which the user has to make payments, taxes owed to the government, a legal judgment against the user, or any other situation in which the use owes a debt to another entity or person.

### Memory

A “memory” or “memory device” is any computer readable medium configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like.

### Mobile Device

A “mobile device” is any mobile communication device, such as a cellular telecommunications device (i.e., a cell phone or mobile phone), personal digital assistant (PDA), a mobile Internet accessing device, a tablet computer, a laptop, or other mobile device.

### Money Market

A “money market” is an aggregation of buyers and sellers actively trading money market instruments.

### Money Market Deposit Account

A “money market deposit account” is a bank deposit account that pays interest based on the money markets current interest rates. Generally, money market deposit accounts provide higher rate of interest than might otherwise be earned in checking or savings accounts. As compared with demand deposit accounts, money market deposit accounts typically limit the number of transactions in the account within a given time period.

### Monitor

To “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information.

### Online Banking Account

An “online banking account” is an account that is associated with one or more user accounts at a financial institution and that can be accessed by a user over a network (e.g., the Internet) via a computer device, such as a personal computer, laptop, or mobile device (e.g., a smartphone or tablet). For example, the user may have an online banking account that is associated with the user's checking account, savings account, investment account, and/or credit account at a particular financial institution. A user may access an online banking account to view account balances, view transaction history, view statements, transfer funds, and pay bills. More than one user may have access to the same online banking account.

### Outflow of Funds, Outflows, Outgoing Funds

Refers to funds outgoing from the user's assets (e.g., user's accounts, or the like) to cover liabilities, such as payments for housing (e.g., rent or mortgage), bills, health care insurance and other costs, heat, water, food, car, boat, transportation, or like, which illustrates all of the essential (e.g., necessary or semi-necessary to the user) costs that cover what the user currently uses to live.

### Payment

A “payment” is a monetary amount or item of monetary value transferred from one individual or entity to another individual or entity in return for receipt of good(s) and/or services.

### Processor

A “processor” or “processing device” refers to a device or combination of devices having circuitry used for implementing the communication and/or logic functions of a particular system. For example, the processor may include a digital signal processor device, a microprocessor device, and various analog to digital converters, digital to analog converters, and/or other support circuits. Control and signal processing functions of the system are allocated between these devices according to their respective capabilities. The processor may also include the functionality to encode and interleave messages and data prior to modulation and transmission.

### Retirement Planning

“Retirement planning” in a financial context may refer to the allocation of funds and decisions made for the use of funds incoming and outgoing in an attempt to achieve financial independence, so that the need to be gainfully employed is optional rather than a necessity. “Retirement planning” may relate to anything that involves determining how the user should utilize assets in order to try to maximize the use of the asset to live. In some embodiments, retirement planning models estimate a user's income immediately prior to retirement and adjust this income downward to reflect an income necessary for the user to maintain a satisfactory lifestyle. In some embodiments, a retirement planning model incorporates the user's current health and medical history and extrapolate the annual living expenses through the years in retirement. In some embodiments, retirement planning may be provided to the user by a financial institution, or other entity.

### Transaction

A “transaction” refers to any communication between a user and the financial institution or other entity monitoring the user's activities. For example, a transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

### User

A “user” may be a financial institution customer (e.g., an account holder or a person who have an account (e.g., banking account, credit account, or the like)). In one aspect, a user may be any financial institution customer involved in retirement planning with the financial institution or any other affiliate entities associated with the financial institution. In some embodiments, the user may be an individual who may be interested in opening an account with the financial institution. In some other embodiments, a user may be any individual who may be interested in enrolling in the retirement plan offered by the financial institution. In some embodiments, a “user” may be a financial institution employee (e.g., an underwriter, a project manager, an IT specialist, a manager, an administrator, an internal operations analyst, bank teller or the like) capable of operating the system described herein. For purposes of this invention, the term “user” and “customer” may be used interchangeably.

### User Interface

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

### A System for Assessing Impact of Financial Events on Retirement Planning

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Typically, retirement planning models estimate a user's income immediately prior to retirement and adjust this income downward to reflect an income necessary for the user to maintain a satisfactory lifestyle. Most retirement planning models incorporate the user's current health and medical history and extrapolate the annual living expenses through the years in retirement. The present invention provides the functional benefit of incorporating specific, customized financial events (e.g. medical expense, a child move, death of spouse, or the like) to dynamically recalculate the effect of said financial events on the user's retirement plan.

In some embodiments, a “user” may be a financial institution customer (e.g., an account holder or a person who have an account (e.g., banking account, credit account, or the like)). In one aspect, a user may be any financial institution customer involved in retirement planning with the financial institution or any other affiliate entities associated with the financial institution. In some embodiments, the user may be an individual who may be interested in opening an account with the financial institution. In some other embodiments, a user may be any individual who may be interested in enrolling in the retirement plan offered by the financial institution. In some embodiments, a “user” may be a financial institution employee (e.g., an underwriter, a project manager, an IT specialist, a manager, an administrator, an internal operations analyst, bank teller or the like) capable of operating the system described herein. For purposes of this invention, the term “user” and “customer” may be used interchangeably.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

As used herein, a “user interface” may be a graphical user interface. Typically, a graphical user interface (GUI) is a type of interface that allows users to interact with electronic devices such as graphical icons and visual indicators such as secondary notation, as opposed to using only text via the command line. In some embodiments, the graphical user interface may include both graphical elements and text elements.

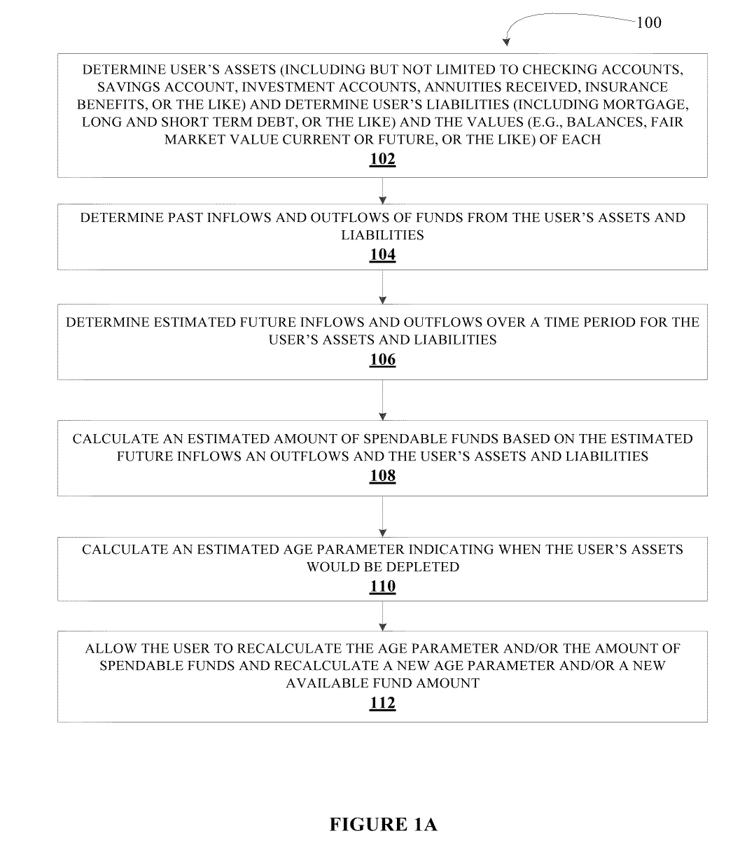

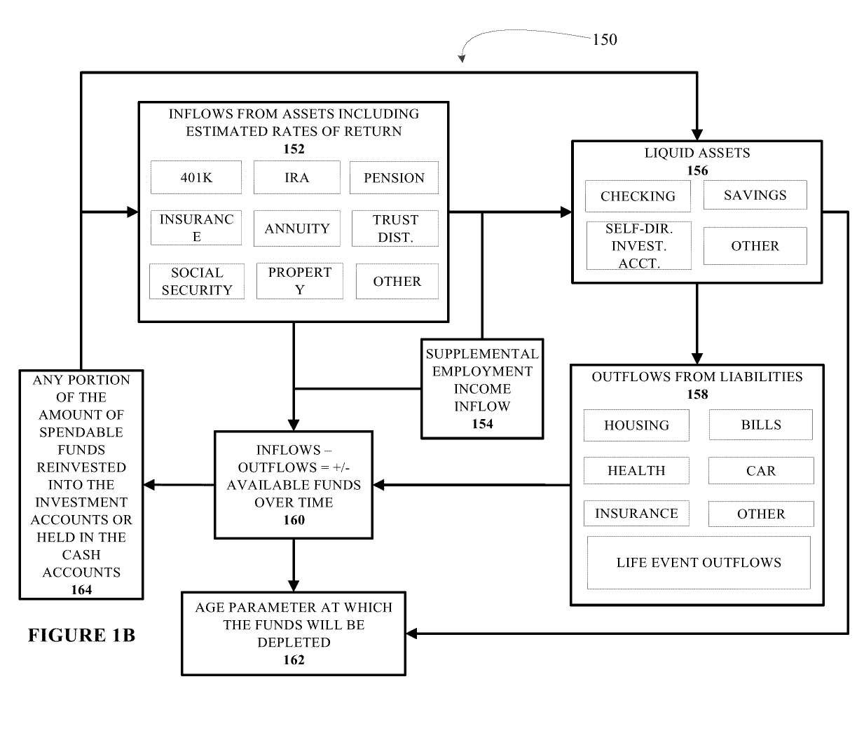

FIG. 1A illustrates a high-level process flow for retirement planning based on fund distributions 100. As illustrated by block 102 of FIG. 1, embodiments of the invention comprise determining a user's assets and the values of the assets (e.g., balances of the account, current or estimated future fair market values of the property, or the like). The user's assets may include but are not limited to checking accounts, savings accounts, investment accounts (e.g., with regular disbursements and penalties for principal withdrawals, or self-directed accounts that more liquid without penalties), annuity accounts (e.g., social security, claim awards, reverse mortgages, or the like), insurances benefit accounts (e.g., one time or reoccurring), property owned by the user (e.g., investment property, rental property, or the like), or other like assets that may provide regular or semi-regular recurring payments, assets that are or are similar to cash accounts, or assets that need to be sold in order to realize cash values of the assets. In some embodiments the assets may be illiquid (e.g., have penalties or may take time to convert into cash) or may be liquid (e.g., can be converted to cash in a couple of days without penalty). Moreover, block 102 of FIG. 1A illustrates that embodiments of the invention further comprise determining a user's liabilities and the values of the liabilities (e.g., amount owed, or the like). The user's liabilities may include a mortgage, long and short term debit, payments owed on other personal property or legal judgments against the user, or the like). In some embodiments all of the assets and liabilities are determined in order to get an idea of what the values of the assets and liabilities are in order to determine how long the inflows and outflows for the user may last.

As illustrated by block 104 in FIG. 1A, embodiments of the invention further include determining past inflows of funds received from or deposited into the user's assets (e.g., user's accounts, or the like), such as paychecks, 401K disbursements, pension disbursements, or the like. Block 104 further illustrates that past outflows of funds from the user's assets (e.g., user's accounts, or the like) are determined, such as payments for housing (e.g., rent or mortgage), bills, health care insurance and other costs, heat, water, food, or like, which illustrates all of the essential (e.g., necessary or necessary to the user) costs that cover what the user currently uses to live.

Block 106 of FIG. 1A illustrates that the financial institution determines estimated future inflows and outflows over one or more time periods (e.g., daily, weekly, bi-weekly, monthly, yearly, averages of each, for multiple specific time periods in the future, or the like). The estimated inflows and outflows are based on the user's past inflows and outflows, future scheduled inflows and outflows, the inflows and outflows that the financial may determine will exist in the future, and/or other like estimates. The estimates made for the inflows and outflows by the financial institutions may account for seasonal changes, one time large expenses, knowledge of a change in the user's life, such as moving to a different house, no longer supporting a dependent child, parent, friend, or the like, or any other inflow or outflow that may occur for the user.

As illustrated by block 108 in FIG. 1A the estimated amount of spendable funds per period of time may be calculated based on the estimated inflows and outflows from the users assets, such as the user's accounts that provide a distribution of funds to the user and the user's account with which the user pays for expenses. The estimated amount of spendable funds illustrates the amount of money a user can spend above the user's cost of living expenses for entertainment, vacations, gifts, or other like non-essential expenses (e.g., fun money, safe to spend amount, or the like) while maintaining enough funds to reach a certain age (e.g., age parameter at which the user's funds will be depleted and will no longer be able to cover the outflows).

As illustrated by block 110 in FIG. 1A, either after, at the same time, or before the estimated amount of spendable funds is calculated an estimated age parameter (estimated amount of time associated with the amount of available funds in the user's financial institution accounts) is calculated that illustrates based on the user's assets, liabilities, estimated inflows, and estimated outflows the age at which the user will run out of funds, or stated another way when the user's outflows are greater than the user's inflows and the user has no additional assets to cover the difference. For example, at the same time the funds from the user's assets are flowing into the user's cash accounts, or other like accounts, the values (e.g., balances) where the fund inflows are coming from are being depleted (e.g., with the exception of annuity type funds such as social security benefits, life annuity payments, pension inflows, or the like). There comes a point in time in which the value of the user's assets (e.g., accounts, assets that the user has mortgaged, or the like) are depleted and the user can no longer cover the outflows.

Block 112 of FIG. 1A illustrates that the user may be allowed to change the amount of spendable funds per the time period (e.g., week, bi-weekly, monthly, six month, yearly, or the like) and/or the age parameter, for example in order to recalculate the spendable amount of funds and/or recalculate the age parameter to identify how long the funds will last based on how much the user wants to spend per the time period, or to identify how much the user can spend based on how long the user wants the funds to last. This information can be controlled and displayed in user interfaces described in further detail later.

It should be understood that when describing a user throughout this invention, the use of the term user may be replaced by users, which indicates that the invention may also include pulling information from the accounts of one or more users (e.g., customers). The multiple users may include a household of people (e.g., husband and wife, parent and child, multiple family members, or the like), which may determine the available funds amount and/or the age parameter for multiple users, for example a household. In still other embodiments, with respect to the actions that a user may take that are described herein, the user may allow or designate another family member, a financial advisor, an estate planner, a trustee, or the like (e.g., otherwise described as a designee) in order to take an action in place of the user. These designees may use the information available to the user for retirement planning purposes during retirement of the user and/or after the user passes away to help plan the user's retirement and/or distribute the user's assets.

FIG. 1B illustrates a flow chart indicating how the amount of spendable funds and/or an age parameter are influenced, in accordance with one embodiment of the invention. Block 152 illustrates a number of assets, such as types of accounts, investments, annuities, property, or the like that may provide a stream of income (or negative steam of income) or payments over a period of time, but which may also be illiquid or otherwise difficult to convert into cash. For example, types of assets that provide disbursements may be a 401K that requires minimum disbursements to the user over a period of time at a specific age; an IRA that requires minimum disbursements to the user over a period of time at a specific age; a pension account that may provide disbursements until the user passes away; insurance benefits that may be distributed as an annuity for a period of time or as a lump sum; a trust account from which disbursement are made, property that provides rental income to the user, social security income or death benefits that pays disbursements for a period of time (e.g., a specific amount of time or for the life of a beneficiary), or other like annuity. In some embodiments of the invention the assets may include estimated rates of returns such that not only are the disbursements used in determining the amount of spendable funds and/or age parameter, but the principal and growth of the principal over time may be used in determining the amount of spendable funds and/or age parameter.

Block 154 illustrates that the user may also have a full-time and/or part time job that provides additional income inflows, such as supplemental employment income inflows, to the user and/or user accounts. The amount of estimated supplemental employment income may be determined based on the hours that the user works, which may be estimated over a period of time, and as such be increased, diminished, or stop based on the age of the user, the number of hours worked over time, increases or decreases in pay over time, and/or other factors that may indicate how long a user may have supplemental income in the future.

As illustrated by block 152 and 154 the inflows from disbursement accounts or other assets, and/or the inflows from supplemental employment income inflow, may be utilized directly to pay for outflows, and thus, be used to calculate the amount of spendable funds illustrated in block 160 described below. In other embodiments of the invention the inflows from disbursement accounts or other assets, and/or the inflows from supplemental employment income inflow may be distributed to liquid or semi-liquid accounts, described in further detail below with respect to block 156.

Block 156 illustrates liquid (e.g., liquid or semi-liquid) assets, such as accounts that may be equivalent to cash or assets that can be converted quickly into cash. For example, the liquid accounts may be checking accounts, savings accounts, self-directed investment accounts, money market accounts, or the like. These liquid accounts may be utilized to pay for the outflows directly as illustrated by block 158 in FIG. 1B, which are discussed in further detail later. In some embodiments these types of accounts may be one of the last accounts that may be utilized to pay for outflows after the inflows from block 152 are exhausted (e.g., with the exception of lifetime annuity accounts). Some of these accounts may also have rates of return (e.g., savings accounts, self-directed investment accounts, or the like) which may be factored in when calculating the amount of spendable funds and/or the age parameter.

As illustrated in block 158 the outflows of the users 9 may include the payments that the user makes in order to live (e.g., necessary or semi-necessary to the user for the living expenses and other liabilities of the user). For example, in some embodiments the outflows may include housing outflows, which may cover the expenses of the user for mortgage payments, taxes, insurance, or the like that the user has to pay in order to maintain a residence. In other examples, the outflows may be related to bills, such as electric, gas, water, or the like. The user's health care cost, such as user's health care premiums and yearly estimated cost may be included. The user may have car payments that are due on a monthly (or other time period) basis. The user may also have insurance payments for the user's car, life, or the like. In addition, there may be other outflows, such as but not limited to child care payments, cell phone payments, internet, and/or other entertainment expenses that may or may not be included in the outflow calculations (e.g., may or not be considered essentials or semi-essentials). The outflows may also include some life event outflows that may be easily predictable, non-repeating outflows, and/or only periodic outflows (e.g., occurs more than the time period for which the outflows are calculated), such as but not limited to paying for a child's college, paying for a wedding, or other like life events that affect the user's outflows. As illustrated by block 152, 154, and 156 some of these outflows may be paid by one or more of the inflows, the supplemental employment income inflow, and/or the liquid assets either directly or indirectly. As such, one or more of the user's assets may have a balance that is depleted over time as the outflows are paid.

Block 160 illustrates the amount of spendable funds per the time period is determined by taking the difference between the inflows and outflows. As such, the amount of spendable funds illustrates the amount of money that a user has to spend above the user's outflows per the time period. For example, the amount of spendable funds may be utilized by the user to spend on trips, electronics, entertainment (e.g., dinners, moves, shows, or the like), to spend on family members, or the like. The amount of spendable funds is the amount of money that the user is safe to spend over the time period, without spending negative amounts of money on the outflows.

As illustrated by block 162, the amount of spendable funds may be utilized, along with the user's assets and liabilities, in order to determine an age parameter at which the user's assets are estimated to be depleted. As such, the age parameter illustrates the age at which the user will not be able to cover the outflows. For example, as the user's inflows from block 152 are depleted, there becomes a point in time when the user's inflows will not cover the user's outflows. At this point in time, the outflows will be covered by the balances of the user's liquid assets (e.g., cash accounts or other like cash accounts). As such, a calculation for an age parameter may be made when the total assets of the user (e.g., inflows from assets and liquid asset accounts) would not cover the outflows for the user's liabilities. In some embodiments the age parameter may be infinity as the user's inflows are so great (e.g., payments received in dividends, interest rates, rental payments received) that they will never be depleted enough to be less than the user's outflows.

Block 164 illustrates that in some embodiments the user may not spend the amount of spendable funds, and as such depending on the how the outflows were paid, the unspent fund amount may be reinvested into the liquid assets (e.g., self-directed accounts, checking accounts, savings accounts, or the like) or back into more illiquid assets, such as purchases of property or other non-liquid assets.

It should be understood that the determination of the amount of spendable funds over the time period and/or the age parameter may change in real-time or near real-time as the rate of return on the assets change (e.g., stock values change, rental income changes or goes away, assets are depleted, big purchases are made or sold, or the like), and costs of the liabilities change (e.g., damage to property than needs repair, variable interest rate changes, life events occur that deplete assets, loans are taken out or paid off, or the like). As such, the present invention may be constantly in real-time or near real time, or over various intervals, recalculated in order to provide a more accurate amount of spendable funds and/or age parameter to the user, such that the user is better able to plan for retirement. Moreover, as illustrated in further detail later the user may be able to adjust the amount of spendable funds and/or the age parameter in order to determine how changes in spending habits affect the age at which the user's assets are depleted, or vice versa.

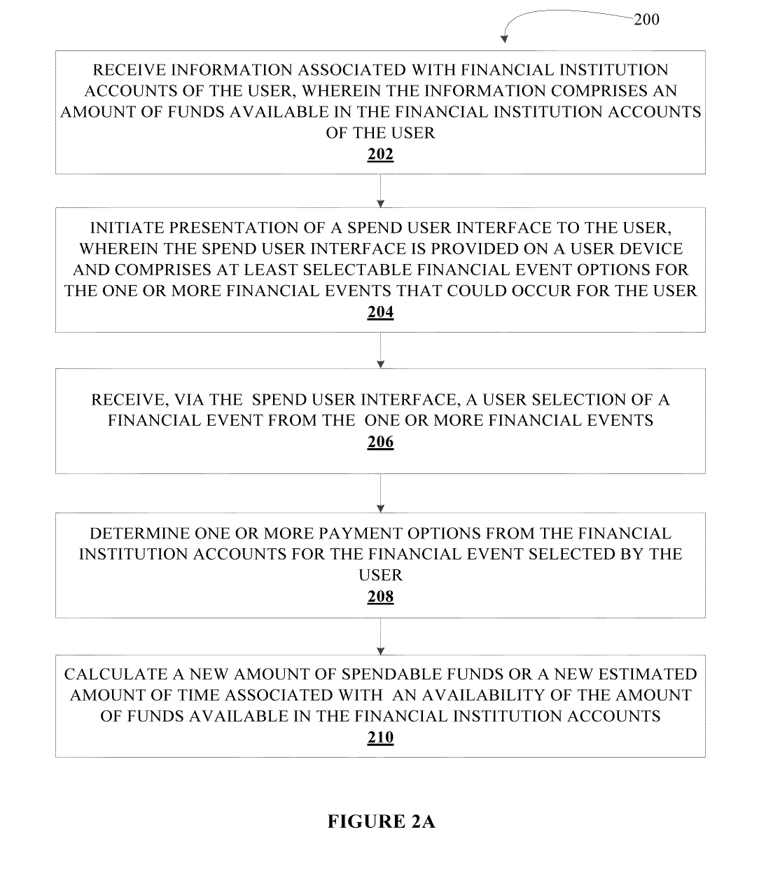

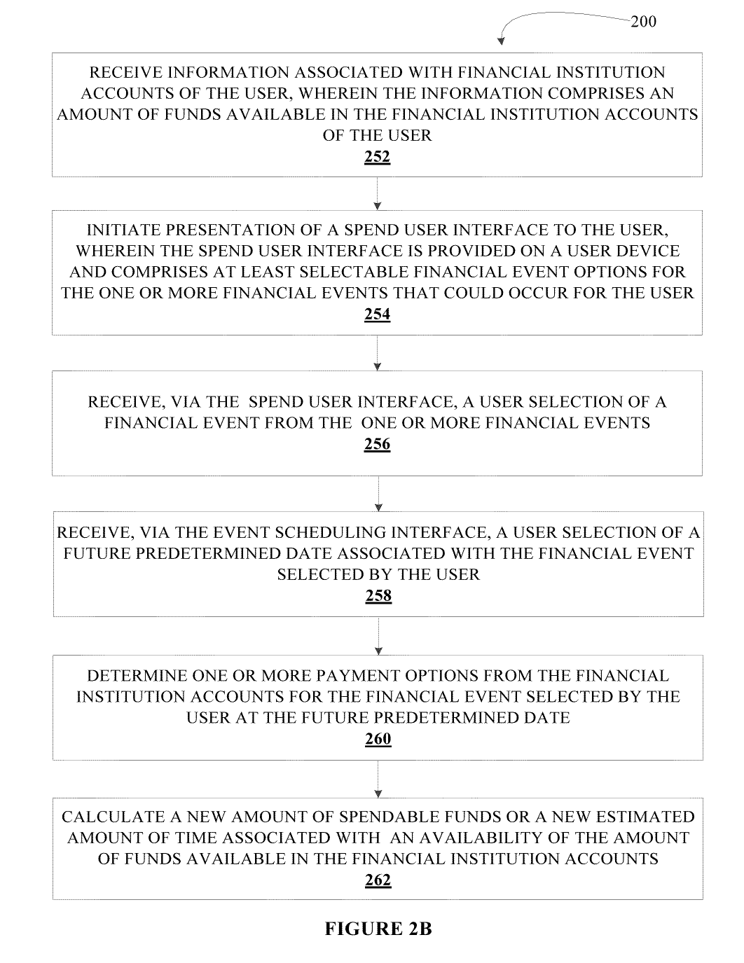

FIG. 2A illustrates a high level process flow 200 for a system for assessing impact of financial events on retirement planning. As shown in block 202, the process flow includes receiving information associated with the financial institution accounts of the user, wherein the information comprises an amount of funds available in the financial institution accounts of the user. In one aspect, the one or more financial institution accounts include, but are not limited to, checking accounts, savings accounts, investment accounts, and retirement accounts such as individual retirement accounts (IRA), Roth individual retirement accounts, accounts associated with assets owned by the user, or the like. In this regard, the system may be configured to receive the information from a distributed network of servers, wherein each server is associated with a financial institution account of the user. In some embodiments, the information received includes an amount of funds available in the financial institution accounts of the user, an amount of outgoing funds of the user, and an amount of incoming funds of the user. In one aspect, the amount of outgoing funds and the amount of incoming funds are associated with a specific time period such as daily, weekly, monthly, annually, or the like. In some embodiments, the amount of outgoing funds of the user is calculated based on the user's anticipated expenses for the specific time period. In some other embodiments, the amount of incoming funds of the user is calculated based on the user's earnings for the specific time period, for example the distributions received from various assets.

In some embodiments, the system may be configured to process the information associated with the financial institution accounts of the user. In this regard, the system may be configured to calculate an amount of spendable funds (e.g., otherwise described herein as an available fund amount) associated with the user based on the amount of funds available in the financial institution accounts, the amount of outgoing funds, and the amount of incoming funds for the time period. In one aspect, the amount of spendable funds may be calculated for a specific time period, as previously discussed herein. For example, the amount of spendable funds may be calculated for every day, every week, every month, or the like. In addition, the system may be configured to calculate an estimated amount of time associated with an availability of the amount of funds available in the financial institution accounts (e.g., an age parameter) based on at least the amount of spendable funds and the amount of funds available in the financial institution accounts, as previously discussed herein. For example, consider a situation where the amount of spendable funds available to the user every month is $2500 and the amount of funds available in the financial institution accounts of the user is $300,000. Based on user's assets, liabilities, estimated inflows, and estimated outflows, the estimated amount of time associated with the availability of the amount of funds may be 120 years, in that, if the user spends $2500 every month, based on factors such as the user's assets, rates associated with return on investments, liabilities, estimated inflows, estimated outflows, or the like, the user may continue to maintain a consistent lifestyle for until the user is, for example, 120 years old before the amount of funds available in the financial institution accounts is depleted. In one aspect, determining the amount of time associated with the availability of the amount of funds is based on at least the current age of the user.

In response, the process flow includes initiating presentation of a spend user interface to the user on a user device, wherein the spend user interface is provided on a user device and comprises at least selectable financial event options for the one or more financial events that could occur for the user, as shown in block 204. In one aspect, the system may be configured to present on the spendable user interface, the amount of spendable funds associated with the user and the estimated amount of time associated with the availability of the amount of funds available in the financial institution accounts.

In some embodiments, the one or more financial events may result in unexpected income and/or unexpected expenditure for the user. In this regard, in one aspect, the one or more financial events may include, but are not limited to a medical expense such as a surgical procedure, a recurring physical exam, or the like, an investment property purchase, an unexpected trip, a child moving back home, or the like. In another aspect, the one or more financial events may include but are not limited to an unexpected income from inheritance, death of spouse, or the like.

As shown in block 206, the process flow includes receiving, via the spend user interface, a user selection of a financial event from the one or more financial events. In response, the system may be configured to initiate presentation of event information user interface to the user, wherein the event information user interface is provided on the user device and comprises at least selectable options associated with the financial event selected by the user and enables the user to input financial event information associated with the financial event selected by the user. In some embodiments, the event information user interface may include information associated with the financial event selected by the user. In one aspect, the event information may include one or more predefined selectable options for the user. For example, if the user selects a financial event related to a medical expense, the event information interface may provide the user with one or more predefined options or questions related to the nature of the medical expense such as a heart bypass, a colonoscopy, an endoscopy, radiation, or the like. In another aspect, the event information may include one or more predefined questions associated with the selected financial event. In this regard, the system may be configured to enable the user to provide information associated with the one or more predefined questions. In another aspect, the event information may enable the user to customize the event information user interface by creating additional options to enter selective information. For example, the user may require a medical procedure not included in the one or more predefined options. In such cases, the system may be configured to enable the user to create a customized event information option to enter selective information. In some embodiments, the system may be configured to analyze the one or more financial events selected by the user and provide tips for preventative care. For example, if the selected financial event is a heart bypass surgery, the system may be configured to provide the user with one or more cardiovascular tips for better health. In some embodiments, the one or more tips provided may include financial advice to enable the user to budget assets effectively to pay for the selected financial event.

As shown in block 208, the process flow includes determining one or more payment options from the financial institution accounts for the financial event selected by the user. In some embodiments, in response to receiving the event information from the user, the system may be configured to initiate presentation of a payment option user interface to the user on the user device, wherein the payment option user interface includes one or more payment options associated with the event information. In one aspect, the system may be configured to access the distributed network of servers to determine the financial event costs based on the financial event information. For example, if the user selects a heart bypass option as the medical expense, the payment option user interface may generate one or more payment options based on factors such as medical insurance, which may be gathered from third-party websites, applications, systems, or the like, internal financial institution stored information, or from other like businesses. In this regard, the system may be configured to generate an estimated medical payment for a heart bypass with medical insurance, estimated medical payment for a heart bypass with Medicaid, and/or estimated medical payment for a heart bypass without insurance. In one aspect, in the event that the user selects the option of estimated medical payment with medical insurance, the system may be configured to receive the user's current medical insurance information. In another aspect, the system may be configured to store the user's health insurance information and use the stored health insurance information prior to estimating the medical payment. In this regard, the system may be configured to confirm with the user that the medical insurance information on file is the user's current medical insurance. In one aspect, the system may be configured to recommend payment options based on medical insurance payment information such as a deductible amount.

In response, the system may be configured to receive, via the payment option user interface, at least one of the one or more payment options based on at least a user selection of the one or more payment options. As shown in block 210, in response to receiving at least one of the one or more payment options from the user, the process flow includes calculating a new amount of spendable funds (e.g., available fund amount) or a new estimated amount of time associated with an availability of the amount of funds available in the financial institution accounts (e.g., age parameter). In some embodiments, the system may be configured to receive a user input associated with the new amount of spendable funds or the new estimated amount of time and adjust the amounts accordingly. Continuing from the previous example, assuming that the aggregate of the estimated cost of the one or more selected financial events, after all expenses, amounts to $84,000, the system may be configured to calculate a new amount of spendable funds for the amount of available funds (e.g. $1800) in the user's financial institution accounts to be available to the user until the user is 120 years old. The system may be configured to take into account factors such as the user's assets, rates associated with return on investments, liabilities, estimated inflows, estimated outflows, or the like to calculate the new amount of spendable funds. In this scenario, since the amount of spendable funds decreases from $2500 to $1800, the user's lifestyle may be affected significantly. The system may enable the user to adjust the amount of spendable funds in an attempt to maintain similar lifestyle. Consequently, the system may be configured to recalculate the age parameter based on the adjusted amount of spendable funds and factors such as the user's assets, rates associated with return on investments, liabilities, estimated inflows, estimated outflows, or the like. Similarly, the user may decide to improve current lifestyle and increase the amount of spendable funds every month. The system may be configured to enable the user to adjust the estimated amount of time (e.g. age parameter) associated with the amount of available funds in the user's financial institution accounts by reducing the estimated life expectancy of the user. In response, the system may be configured to recalculate a new amount of spendable funds based on the adjusted age parameter and factors such as the user's assets, rates associated with return on investments, liabilities, estimated inflows, estimated outflows, or the like, thereby increasing the amount of spendable funds available to the user. In some embodiments, the amount of spendable funds and the estimated amount of time associated with the availability of funds available in the financial institution accounts have a negatively correlated relationship.

In response to calculating new amount of spendable funds and/or new estimated amount of time, the system may be configured to initiate presentation of an updated spend user interface to the user, wherein the updated spend interface is provided on the user device and comprises the new amount of spendable funds or the new estimated amount of time, one or more of the financial institution accounts used to cover the one or more payment options, and an amount from one or more of the financial institution accounts.

In some embodiments, the system may be configured to establish a payment disbursement plan to enable the user to pay for the one or more financial events. In one aspect, the updated spend user interface may present the payment disbursement plan to the user on the user device, wherein the payment disbursement plan may include a percentage allocation of amounts from each of the one or more financial institution accounts to be applied towards the one or more financial events selected by the user. In response to receiving the payment disbursement plan, the system may be configured to enable the user to execute the plan by distributing the funds from the various accounts into the user's checking account or other account from which the funds will be paid, by scheduling the disbursement for the future point in time when the financial event is likely to occur, or scheduling an alert to remind the user of the fund allocations when the financial event occurs. In some embodiments, the system may be configured to enable the user to adjust the percentage allocation of the amount from the one or more financial institution accounts of the user, wherein adjusting further comprises adjusting a current weight of one or more holdings associated with the one or more financial institution accounts of the user.

In some embodiments, the system may be configured to determine whether the user is ahead of a plan, on plan, or behind a plan based on at least the amount of outgoing funds, the amount of incoming funds, and the amount of spendable funds. In one aspect, the system may be configured to determine that the user is ahead of a plan if the amount of outgoing funds and spendable funds is less than the amount incoming funds. In another aspect, the system may be configured to determine that the user is on plan if the amount of outgoing funds and spendable funds is equal to the amount of incoming funds. In yet another aspect, the system may be configured to determine that the user is behind plan if the amount of outgoing funds and spendable funds is greater than the amount of incoming funds for one or more time periods.

The present invention provides the functional benefit of providing the amount of spendable funds, amount of time associated with the availability of funds available in the financial institution accounts, or the like described above as visual information to the user on an interactive graphical user interface. In this regard, the system is configured to receive user input and dynamically determine updated amounts based on at least retrieving information associated with the one or more financial institution accounts of the user and event information from disparate databases in substantially real-time (e.g., real-time or near real time). In this way, the present invention enables the user to visually recognize the impact of the one or more financial events selected.

In some embodiments, the system may be configured to recommend one or more products and/or services to the user based on the one or more financial events selected by the user. In one aspect, the system may be configured to recommend one or more merchants and/or service provider associated with the selected financial event. In another aspect, the system may be configured to recommend a specific time period for purchase based on existing offers and/or discounts available to the user. In some other embodiments, the system may be configured to recommend one or more offers associated with one or more products and/or services previously purchased by the user for the one or more financial events selected. For example, if the financial event selected by the user is “car purchase”, the system may be configured to recommend a specific car merchant, financing options, discounts/rebates on car accessories, warranties, or the like.

FIG. 2B illustrates a high level process flow 250 for assessing impact of financial events on retirement planning at a predetermined future date. As shown in block 252, the process flow includes receiving information associated with financial institution accounts of the user, wherein the information comprises an amount of funds available in the financial institution accounts of the user. In response, the process flow includes initiating presentation of a spend user interface to the user, wherein the spend user interface is provided on a user device and comprises at least selectable financial event options for the one or more financial events that could occur for the user, as shown in block 254. In response, the process flow includes receiving, via the spend user interface, a user selection of a financial event from the one or more financial events, as shown in block 256.

In addition to receiving the user selection of a financial event from the one or more financial events, the process flow includes receiving, via an event scheduling interface, a user selection of a future predetermined date associated with the financial event selected by the user, as shown in block 258. For example, the user may be interested in purchasing a car. In this scenario, the user may select the “car purchase” financial event from the one or more financial events listed on the spend user interface. In addition, the event scheduling interface may enable the user to select a predetermined future date associated with the car purchase. In this regard, in one aspect, the system may be configured to initiate presentation of a calendar on the event scheduling interface to enable the user to select a favorable date. In response, the system may be configured to initiate presentation of event information user interface to the user, wherein the event information user interface is provided on the user device and comprises at least selectable options associated with the financial event selected by the user and enables the user to input financial event information associated with the financial event selected by the user. In some embodiments, the event information user interface may include information associated with the financial event selected by the user. In this example, the event information may include information associated with the car that the user intends on purchasing, such as, model, year, body style, gas mileage, preferred manufacturers, or the like. The user may also input a cost associated with the car, otherwise the financial institution may access third-parties in order to determine a cost of the car through third-party applications, websites, systems, servers, or the like. In other embodiments the costs associated with events may be determine in the same way as described with respect to the car.

In response, the process flow includes determining one or more payment options from the financial institution accounts for the financial event selected by the user at the future predetermined date, as shown in block 260. In some embodiments, the system may be configured to determine one or more payment options for the financial event selected by the user at the time the user selected the financial event on the spend user interface. In some other embodiments, the system may be configured to determine one or more estimated payment options for the financial event selected by the user at the predetermined future date selected by the user. In yet another embodiment, the system may be configured to determine one or more payment options for the financial event selected by the user between the time the user selected the financial event on the spend user interface and the predetermined future date to determine the best payment option for the user based on one or more factors. In one aspect, the one or more factors include, but are not limited to, market information such as a level of market demand, economic trend, demographic, industry standard, government laws and regulations, seasonal price variation, or the like. In other embodiments, the one or more factors may include when it would be best to use one of the financial accounts of the user, such as the user should wait for the financial account until the user can take from an investment account without penalty (e.g., 401K cannot be accessed without penalty until a specific age is reached). In some embodiments, the system may be configured to estimate payment options for the selected financial event based on at least one or more expenses incurred previously by the user from the user's financial institution data. In yet another embodiment, the system may be configured to estimate payment options for the selected financial event based on at least one or more expenses incurred by other financial institution users matching the user's profile from the matching users' financial institution data. In this regard, the user's profile may be determined based on one or more factors such as age, income, location, monthly budgeted expenses, financial events recorded, or the like.

In one embodiment, for example, the user may select “car purchase” as the financial event from the one or more financial events presented to the user on the spend user interface. In response, the system may be configured to determine that the price of the car requested by the user is currently (e.g., in December) $32,000 and at the predetermined future date selected by the user (e.g., in April) is $35,500. In some embodiments, the system may be configured to determine the estimated price of the car requested by the user between December and April and present the price fluctuation to the user on the user device. In one aspect, the price fluctuation may be presented periodically as a weekly fluctuation, a monthly fluctuation, or the like. Moreover, the financial institution may indicate to the user to wait until a future date (e.g., in February) to make the purchase when the user has access to additional funds (e.g., the user can access his IRA without penalty). In this regard, the system may be configured to determine one or more impacts associated with the user's decision to pay for the financial event at the predetermined future date. In one aspect, the system may further be configured to analyze the one or more impacts and provide the user with a recommended predetermined future date based on the one or more determined impacts. The recommended predetermined future date may be any date from the instant that the one or more impacts are determined to the predetermined future date scheduled by the user.

In some embodiments, the one or more payment options for the car purchase may include, but are not limited to, an equated monthly installment option, a one-time payment option, or the like. In this regard, the system may be configured to determine one or more pricing options available from one or more car dealers within a specific geographic radius associated with the location of the user. Other factors included in determining the one or more payment options include a preferred merchant, geographic location of the user, a preferred geographic location, comparable car models, or the like. In some embodiments, the financial institution may indicate to the user to purchase the car with cash, to finance the car, or lease the car based on the user's inflows, outflows, access to financial accounts without penalty, the rate of return for various assets, or the like. For example, the financial institution may suggest to the user to finance the purchase because interest rates are only 1%, and instead of paying cash the user can invest the cash at a higher rate of return. In other examples, the financial institution may indicate that the user should finance the car because accessing the cash to pay for the car outright would result in too many penalties. In one aspect, the system may be configured to recommend one or more payment vehicles for one or more specific financial events. For example, if the financial event is a planned trip, the system may be configured to recommend that the user conduct transactions associated with the trip using a payment vehicle with airline miles rewards. In this regard, the system may recommend that the user conduct transaction using a combination of payment vehicles associated with the financial institution.

In response to receiving payment options, the system may be configured to receive, via the payment option user interface, at least one of the one or more payment options based on at least a user selection of the one or more payment options. In some embodiments, the system may be configured to provide a recommendation to the user based on the selected financial event and the future predetermined date. Continuing from the previous example, the system may be configured to determine that the best time during the year to buy a car is during the month of October, when most showrooms are likely to release the previous year models at relatively cheaper prices to make room for the new yearly car models. In this regard, the system may provide the estimated price of the car requested by the user outside the time period between the time the user selected the financial event on the spend user interface and the predetermined future date.

In response to receiving the user selection of the payment option, the system may be configured to calculate a new amount of spendable funds or a new estimated amount of time associated with an availability of the amount of funds available in the financial institution accounts, as shown in block 262. In some embodiments, the system may be configured to establish a payment disbursement plan to enable the user to pay for the one or more financial events. In one aspect, the updated spend user interface may present the payment disbursement plan to the user on the user device, wherein the payment disbursement plan may include a percentage allocation of amounts from each of the one or more financial institution accounts to be applied towards the one or more financial events selected by the user. In response to receiving the payment disbursement plan, the system may be configured to enable the user to execute the plan.

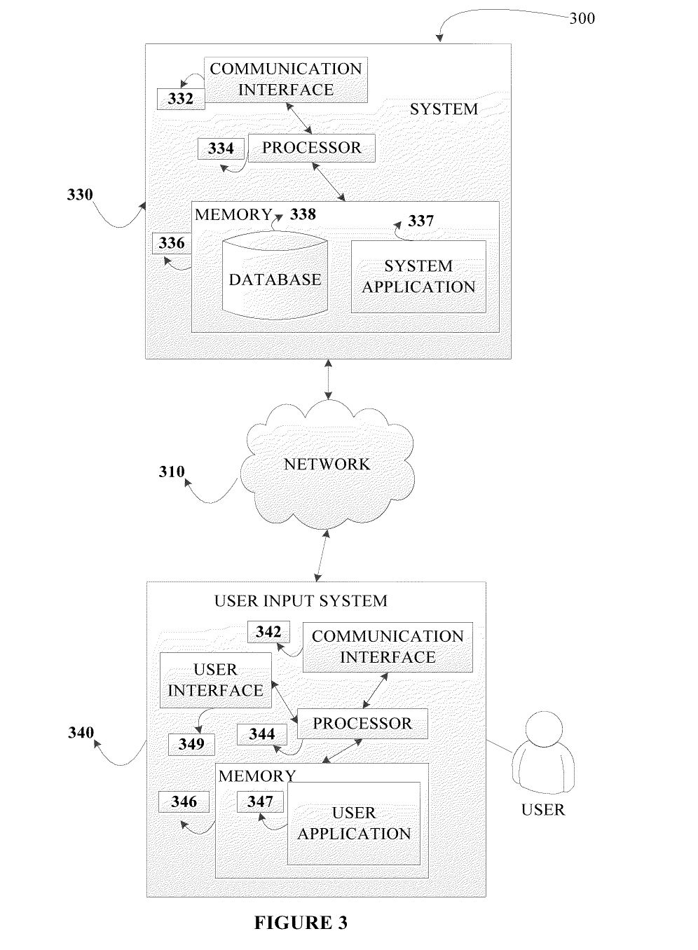

FIG. 3 presents an exemplary block diagram of the system environment 300 for implementing the process flows described herein in accordance with embodiments of the present invention. As illustrated, the system environment 300 includes a network 310, a system 330, and a user input system 340. Also shown in FIG. 3 is a user of the user input system 340. The user input system 340 may be a mobile device or other non-mobile computing device. The user may be a person who uses the user input system 340 to execute a user application 347. The user application 347 may be an application to communicate with the system 330, perform a transaction, input information onto a user interface presented on the user input system 340, or the like. The user application 347 and/or the system application 337 may incorporate one or more parts of any process flow described herein.

As shown in FIG. 3, the system 330, and the user input system 340 are each operatively and selectively connected to the network 310, which may include one or more separate networks. In addition, the network 310 may include a telecommunication network, local area network (LAN), a wide area network (WAN), and/or a global area network (GAN), such as the Internet. It will also be understood that the network 310 may be secure and/or unsecure and may also include wireless and/or wired and/or optical interconnection technology.

The user input system 340 may include any computerized apparatus that can be configured to perform any one or more of the functions of the user input system 340 described and/or contemplated herein. For example, the user may use the user input system 340 to transmit and/or receive information or commands to and from the system 330. In some embodiments, for example, the user input system 340 may include a personal computer system (e.g. a non-mobile or non-portable computing system, or the like), a mobile computing device, a personal digital assistant, a mobile phone, a tablet computing device, a network device, and/or the like. As illustrated in FIG. 3, in accordance with some embodiments of the present invention, the user input system 340 includes a communication interface 342, a processor 344, a memory 346 having an user application 347 stored therein, and a user interface 349. In such embodiments, the communication interface 342 is operatively and selectively connected to the processor 344, which is operatively and selectively connected to the user interface 349 and the memory 346. In some embodiments, the user may use the user application 347 to execute processes described with respect to the process flows described herein. Specifically, the user application 347 executes the process flows described herein.

Each communication interface described herein, including the communication interface 342, generally includes hardware, and, in some instances, software, that enables the user input system 340, to transport, send, receive, and/or otherwise communicate information to and/or from the communication interface of one or more other systems on the network 310. For example, the communication interface 342 of the user input system 340 may include a wireless transceiver, modem, server, electrical connection, and/or other electronic device that operatively connects the user input system 340 to another system such as the system 330. The wireless transceiver may include a radio circuit to enable wireless transmission and reception of information. Additionally, the user input system 340 may include a positioning system. The positioning system (e.g. a global positioning system (GPS), a network address (IP address) positioning system, a positioning system based on the nearest cell tower location, or the like) may enable at least the user input system 340 or an external server or computing device in communication with the user input system 340 to determine the location (e.g. location coordinates) of the user input system 340.

Each processor described herein, including the processor 344, generally includes circuitry for implementing the audio, visual, and/or logic functions of the user input system 340. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 347 of the memory 346 of the user input system 340.

Each memory device described herein, including the memory 346 for storing the user application 347 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 346 includes the user application 347. In some embodiments, the user application 347 includes an interface for communicating with, navigating, controlling, configuring, and/or using the user input system 340. In some embodiments, the user application 347 includes computer-executable program code portions for instructing the processor 344 to perform one or more of the functions of the user application 347 described and/or contemplated herein. In some embodiments, the user application 347 may include and/or use one or more network and/or system communication protocols.

Also shown in FIG. 3 is the user interface 349. In some embodiments, the user interface 349 includes one or more output devices, such as a display and/or speaker, for presenting information to the user. In some embodiments, the user interface 349 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 349 includes the input and display devices of a mobile device, which are operable to receive and display information.

FIG. 3 also illustrates a system 330, in accordance with an embodiment of the present invention. The system 330 may refer to the “apparatus” described herein. The system 330 may include any computerized apparatus that can be configured to perform any one or more of the functions of the system 330 described and/or contemplated herein. In accordance with some embodiments, for example, the system 330 may include a computer network, an engine, a platform, a server, a database system, a front end system, a back end system, a personal computer system, and/or the like. Therefore, the system 330 may be a server managed by the business. The system 330 may be located at the facility associated with the business or remotely from the facility associated with the business. In some embodiments, such as the one illustrated in FIG. 3, the system 330 includes a communication interface 332, a processor 334, and a memory 336, which includes a system application 337 and a structured database 338 stored therein. As shown, the communication interface 332 is operatively and selectively connected to the processor 334, which is operatively and selectively connected to the memory 336.

It will be understood that the system application 337 may be configured to implement any one or more portions of the various user interfaces and/or process flow described herein. The system application 337 may interact with the user application 347. It will also be understood that, in some embodiments, the memory includes other applications. It will also be understood that, in some embodiments, the system application 337 is configured to communicate with the structured database 338, the user input system 340, or the like.

It will be further understood that, in some embodiments, the system application 337 includes computer-executable program code portions for instructing the processor 334 to perform any one or more of the functions of the system application 337 described and/or contemplated herein. In some embodiments, the system application 337 may include and/or use one or more network and/or system communication protocols.

In addition to the system application 337, the memory 336 also includes the structured database 338. As used herein, the structured database 338 may be one or more distinct and/or remote databases. In some embodiments, the structured database 338 is not located within the system and is instead located remotely from the system. In some embodiments, the structured database 338 stores information or data described herein.

It will be understood that the structured database 338 may include any one or more storage devices, including, but not limited to, datastores, databases, and/or any of the other storage devices typically associated with a computer system. It will also be understood that the structured database 338 may store information in any known way, such as, for example, by using one or more computer codes and/or languages, alphanumeric character strings, data sets, figures, tables, charts, links, documents, and/or the like. Further, in some embodiments, the structured database 338 may include information associated with one or more applications, such as, for example, the system application 337. It will also be understood that, in some embodiments, the structured database 338 provides a substantially real-time representation of the information stored therein, so that, for example, when the processor 334 accesses the structured database 338, the information stored therein is current or substantially current.

It will be understood that the embodiment of the system environment illustrated in FIG. 3 is exemplary and that other embodiments may vary. As another example, in some embodiments, the system 330 includes more, less, or different components. As another example, in some embodiments, some or all of the portions of the system environment 300 may be combined into a single portion. Likewise, in some embodiments, some or all of the portions of the system 330 may be separated into two or more distinct portions.

In addition, the various portions of the system environment 300 may be maintained for and/or by the same or separate parties. It will also be understood that the system 330 may include and/or implement any embodiment of the present invention described and/or contemplated herein. For example, in some embodiments, the system 330 is configured to implement any one or more of the embodiments of the process flows described and/or contemplated herein in connection any process flow described herein. Additionally, the system 330 or the user input system 340 is configured to initiate presentation of any of the user interfaces described herein.

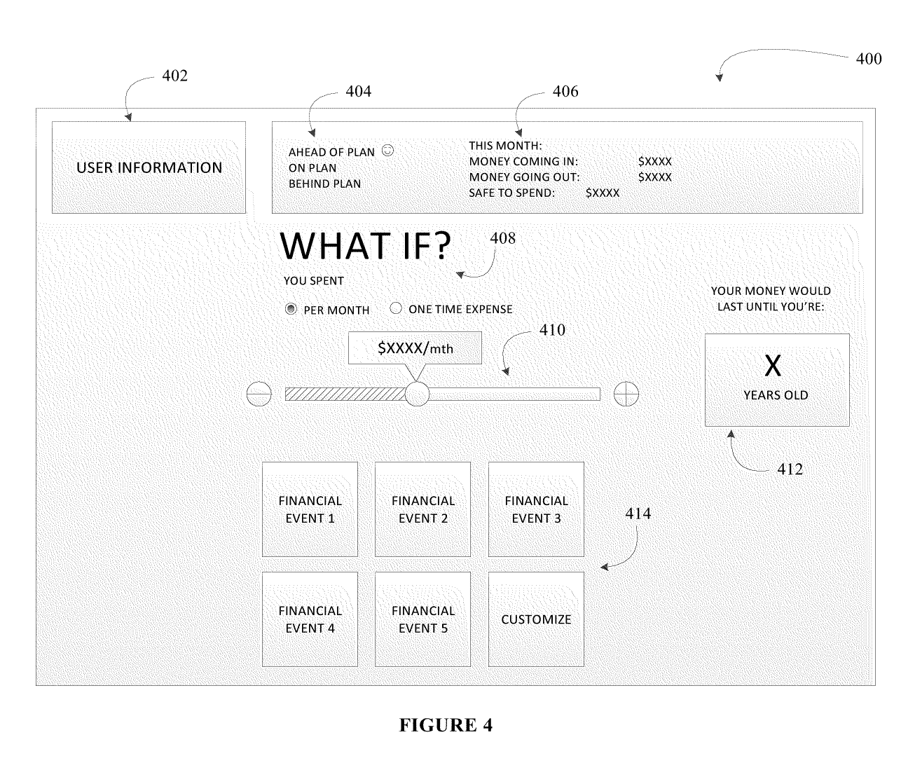

FIG. 4 illustrates an exemplary spend user interface in accordance with an embodiment of an invention 400. In some embodiments, the spend user interface 400 comprises user information 402, user's progress 404, user's monthly finance 406, user's retirement scenario 408, and one or more selectable financial events 414. In one aspect, the user's progress 404 comprises at least one of an indication that the user is ahead of plan, on plan, and/or behind plan. In another aspect, the user's monthly finance summary 406 comprises at least an amount of incoming funds each month, an amount of outgoing funds each month, and a safe to spend amount defined as a difference between the amount of incoming funds and the amount of outgoing funds. As illustrated in FIG. 4, the user's retirement scenario 408 comprises a safe to spend amount 410 (e.g., available fund amount) and an amount of time associated with the availability of funds in the user's one or more financial institution accounts 412 (e.g., age parameter). In some embodiments, the system may be configured to enable the safe to spend amount 410 to be adjustable such that the system may be configured to enable the user to adjust the safe to spend amount 410, thereby modifying at least the amount of time associated with the availability of funds in the user's one or more financial institution accounts 412 and the user's progress 404.

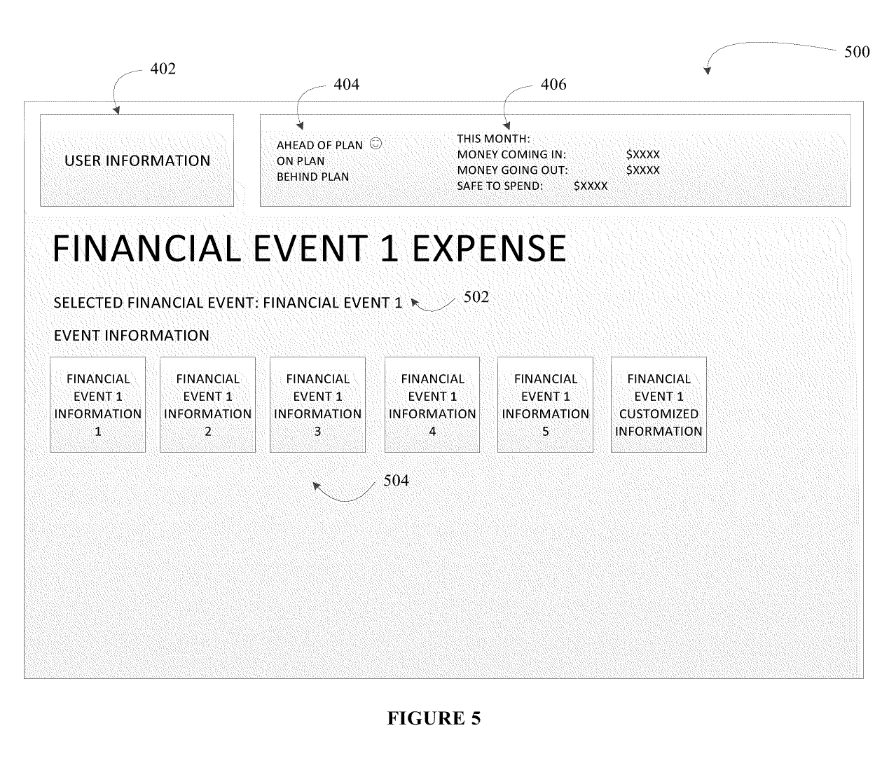

FIG. 5 illustrates an exemplary event information user interface in accordance with an embodiment of an invention 500. In some embodiments, the event information user interface 500 comprises at least user information 402, user's progress 404, user's monthly finance summary 406, an expense associated with the financial event selected by the user 502, and one or more event information sections 504 associated with the financial event selected by the user. In one aspect, the one or more event information sections 504 associated with the financial event may include one or more predefined information options capable of receiving additional information from the user. In another aspect, the one or more event information sections 504 associated with the financial event may include a customizable option to enable the user to customize the information associated with the selected financial event.

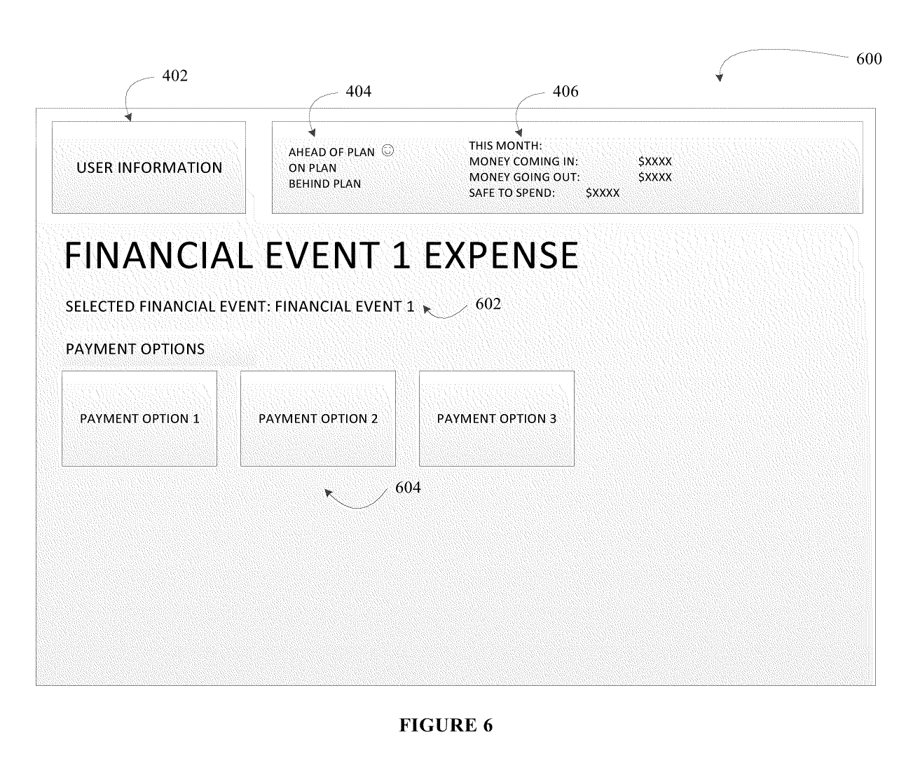

FIG. 6 illustrates an exemplary payment option user interface in accordance with an embodiment of an invention 600. In some embodiments, the payment option user interface 600 comprises at least user information 402, user's progress 404, user's monthly finance summary 406, a selected financial event 602, and one or more payment options 604 associated with the selected financial event.

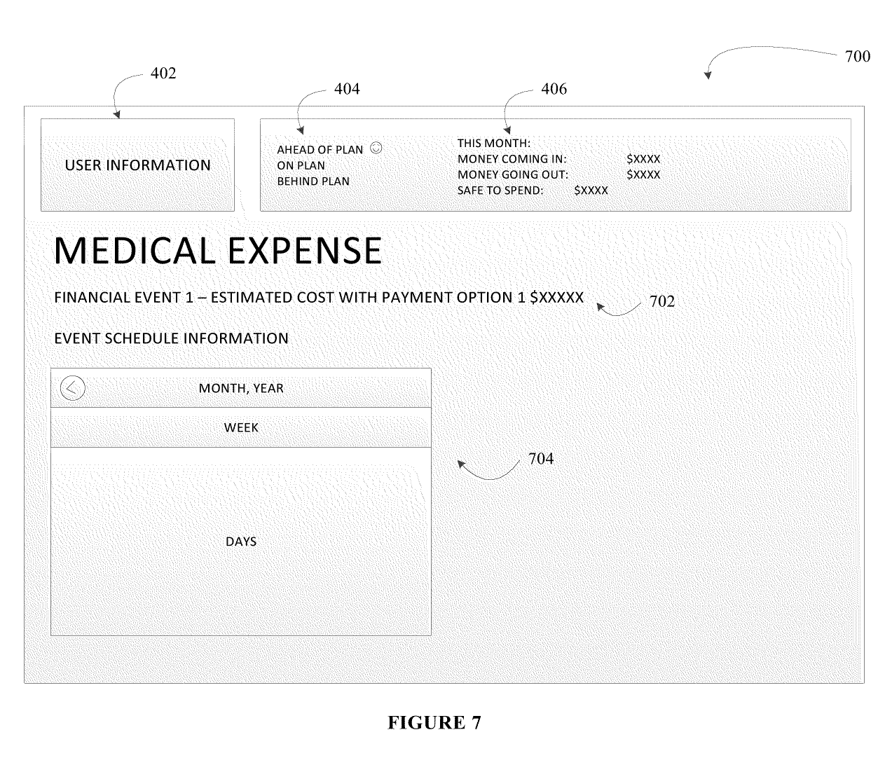

FIG. 7 illustrates an exemplary event scheduling interface in accordance with an embodiment of an invention 700. In some embodiments, the event scheduling interface 700 comprises at least user information 402, user's progress 404, user's monthly finance summary 406, an estimated cost associated with the selected financial event based on at least the selected payment option 702, and a calendar to schedule the financial event 704.

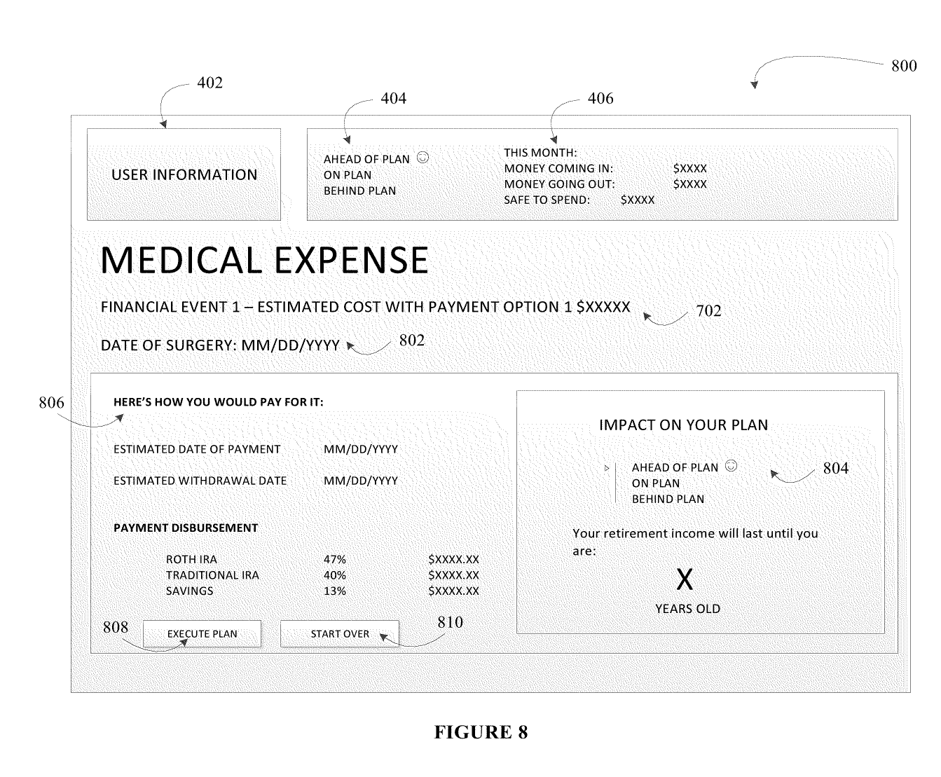

FIG. 8 illustrates an exemplary updated spend user interface in accordance with an embodiment of an invention 800. In some embodiments, the updated spend user interface 800 comprises at least user information 402, user's progress 404, user's monthly finance summary 406, an estimated cost associated with the selected financial event based on the selected payment option 702, a date associated with the selected financial event 802, and a payment disbursement plan 806. In one aspect, the payment disbursement plan 806 includes a potential impact of the payment option on the user's progress 804, an option to enable the user to execute the plan 808, and an option to enable the user to start over 810. In one aspect, the option to enable the user to start over 810 enables the user to redo the payment disbursement plan.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A system for assessing impact of financial events on retirement planning for a user, the system comprising:
at least one non-transitory storage device;
at least one processor; and
at least one module stored in said storage device and comprising instruction code that is executable by the at least one processor and configured to cause said at least one processor to:
establish a communication link with financial accounts of the user, wherein establishing the communication link further comprises establishing an independent communication link with each financial account of the user;
receive, via the established communication link, information associated with financial institution accounts of the user from a distributed network of servers, wherein the information comprises an amount of funds associated with the user's assets, an amount of outgoing funds of the user, and an amount of incoming funds of the user;
calculate an amount of spendable funds associated with the user for a time period, wherein the amount of spendable funds is calculated based on the amount of funds associated with the user's assets, the amount of outgoing funds, and the amount of incoming funds for the time period;
calculate an estimated amount of time associated with an availability of the amount of funds associated with the user's assets based on at least the amount of spendable funds and the amount of funds associated with the user's assets;
dynamically configure a spend user interface comprising interactive graphical visual components to reflect the calculated estimated amount of time associated with the availability of the amount of funds associated with the user's assets, wherein configuring further comprises generating graphical interactive visual components capable of visually communicating an impact of events affecting the calculated estimated amount of time associated with the availability of the amount of funds associated with the user's assets;
establish a communication link with a user device associated with the user, wherein establishing the communication link creates a wireless data channel with the user device;
initiate, via the wireless data channel, presentation of a spend user interface to the user, wherein the spend user interface is provided on the user device and comprises at least the amount of spendable funds associated with the user, the estimated amount of time associated with the availability of the amount of funds associated with the user's assets, and selectable financial event options for one or more financial events, wherein the selectable options comprise the one or more financial events that could occur for the user;
receive, via the spend user interface, a user selection of a financial event from the one or more financial events, wherein the financial event selected by the user results in an unexpected income and/or an unexpected expense for the user;
initiate, via the wireless data channel, presentation of an event information user interface to the user, wherein the event information user interface is provided on the user device and comprises at least selectable options associated with the financial event selected by the user and enables the user to input financial event information associated with the financial event selected by the user, wherein the event information comprises one or more predetermined questions to be presented to the user, the predetermined questions associated with the financial event selected by the user;
receive, via the event information user interface, the financial event information associated with the financial event selected by the user, wherein receiving the financial event information comprises receiving a response to the one or more predetermined questions from the user;
access the distributed network of servers to determine financial event costs based on the financial event information, wherein the financial event costs comprises an estimated amount of funds associated with the unexpected income and/or the unexpected expense;
determine one or more payment options from the financial institution accounts for the financial event selected by the user based on at least the amount of funds associated with the user's assets;
initiate, via the wireless data channel, presentation of a payment option user interface to the user, wherein the payment option user interface is provided on the user device and comprises the one or more payment options for the financial event;
receive, via the payment option user interface, a user selection of at least one of the one or more payment options based on at least a user selection of the one or more payment options;
determine a payment disbursement plan to enable the user to pay for the one or more financial events based on at least the user selection of at least one of the one or more payment options, wherein the disbursement plan comprises a percentage allocation of amounts from the one or more financial institution accounts of the user to be applied towards the one or more financial events selected by the user;
initiate, via the wireless data channel, presentation of the payment disbursement plan for display on the user device;
receive a user input to adjust the percentage allocation of the amount from the one or more financial institution accounts of the user, wherein adjusting further comprises adjusting a current weight of one or more holdings associated with the one or more financial institution accounts of the user;
receive a user confirmation to execute the determined the payment disbursement plan;
initiate an execution of the payment disbursement plan;
calculate a new amount of spendable funds or a new estimated amount of time associated with an availability of the amount of funds associated with the user's assets; and
dynamically re-configure the spend user interface based on at least calculating the new amount of spendable funds or estimated amount of time associated with an availability of amount of funds associated with the user's assets, wherein re-configuring further comprises manipulating the graphical interactive visual components to communicate the new amount of spendable funds or estimated amount of time associated with an availability of amount of funds associated with the user's assets;
initiate, via the wireless data channel, presentation of an updated spend user interface to the user, wherein the updated spend user interface is provided on the user device and comprises the new amount of spendable funds or the new estimated amount of time, one or more of the financial institution accounts used to cover the one or more payment options, and an amount from one or more of the financial institution accounts.

2. The system of claim 1, wherein the module is further configured to cause a processor to determine whether the user is at least one of ahead of a plan, on plan, or behind plan based on at least the amount of outgoing funds, the amount of incoming funds, and the amount of spendable funds;
wherein the user is ahead of a plan when the combination of the amount of outgoing funds and the amount of spendable funds is less than the amount incoming funds;
wherein the user is on plan when the combination of the amount of outgoing funds and the amount of spendable funds is equal to the amount of incoming funds; and
wherein the user is behind plan when the combination of the amount of outgoing funds and the amount of spendable funds is greater than the amount of incoming funds.

3. The system of claim 1, wherein the module is further configured to cause a processor to:
receive a user input related to the estimated amount of time associated with an availability of the amount of funds associated with the user's assets; and
calculate a new amount of spendable funds based on at least the received estimated amount of time associated with the availability of funds associated with the user's assets.

4. The system of claim 1, wherein the module is further configured to cause a processor to:
receive a user input related to the amount of spendable funds; and
calculate a new estimated amount of time associated with an availability of the amount of funds associated with the user's assets based on at least the received amount of spendable funds.

5. The system if claim 1, wherein the module is further configured to cause a processor to:
receive a user input to customize a financial event that could occur for the user, wherein customizing the financial event further comprises receiving, via the spend user interface, one or more additional information associated with the financial event selected by the user;
receive event information associated with the customized financial event that could occur for the user;
access the distributed network of servers to determine the customized financial event costs based on the customized financial event information, or receive a cost input from the user; and
determine one or more payment options from the financial institution accounts for the customized financial event selected by the user based on at least the amount of funds associated with the user's assets, rates of return of the financial accounts, and minimizing any penalties associated with using the funds associated with the user's assets.

6. (canceled)

7. (canceled)

8. A computer program product for assessing impact of financial events on retirement planning for a user, the computer program product comprising a non-transitory computer-readable medium comprising code causing a first apparatus to:
establish a communication link with financial accounts of the user, wherein establishing the communication link further comprises establishing an independent communication link with each financial account of the user;
receive, via the established communication link, information associated with financial institution accounts of the user from a distributed network of servers, wherein the information comprises an amount of funds associated with the user's assets, an amount of outgoing funds of the user, and an amount of incoming funds of the user;
calculate an amount of spendable funds associated with the user for a time period, wherein the amount of spendable funds is calculated based on the amount of funds associated with the user's assets, the amount of outgoing funds, and the amount of incoming funds for the time period;
calculate an estimated amount of time associated with an availability of the amount of funds associated with the user's assets based on at least the amount of spendable funds and the amount of funds associated with the user's assets;
dynamically configure a spend user interface comprising interactive graphical visual components to reflect the calculated estimated amount of time associated with the availability of the amount of funds associated with the user's assets, wherein configuring further comprises generating graphical interactive visual components capable of visually communicating an impact of events affecting the calculated estimated amount of time associated with the availability of the amount of funds associated with the user's assets;
establish a communication link with a user device associated with the user, wherein establishing the communication link creates a wireless data channel with the user device;
initiate, via the wireless data channel, presentation of a spend user interface to the user, wherein the spend user interface is provided on the user device and comprises at least the amount of spendable funds associated with the user, the estimated amount of time associated with the availability of the amount of funds associated with the user's assets, and selectable financial event options for one or more financial events, wherein the selectable options comprise the one or more financial events that could occur for the user;
receive, via the spend user interface, a user selection of a financial event from the one or more financial events, wherein the financial event selected by the user results in an unexpected income and/or an unexpected expense for the user;
initiate, via the wireless data channel, presentation of an event information user interface to the user, wherein the event information user interface is provided on the user device and comprises at least selectable options associated with the financial event selected by the user and enables the user to input financial event information associated with the financial event selected by the user, wherein the event information comprises one or more predetermined questions to be presented to the user, the predetermined questions associated with the financial event selected by the user;
receive, via the event information user interface, the financial event information associated with the financial event selected by the user, wherein receiving the financial event information comprises receiving a response to the one or more predetermined questions from the user;
access the distributed network of servers to determine financial event costs based on the financial event information, wherein the financial event costs comprises an estimated amount of funds associated with the unexpected income and/or the unexpected expense;
determine one or more payment options from the financial institution accounts for the financial event selected by the user based on at least the amount of funds associated with the user's assets;
initiate, via the wireless data channel, presentation of a payment option user interface to the user, wherein the payment option user interface is provided on the user device and comprises the one or more payment options for the financial event;
receive, via the payment option user interface, a user selection of at least one of the one or more payment options based on at least a user selection of the one or more payment options;
determine a payment disbursement plan to enable the user to pay for the one or more financial events based on at least the user selection of at least one of the one or more payment options, wherein the disbursement plan comprises a percentage allocation of amounts from the one or more financial institution accounts of the user to be applied towards the one or more financial events selected by the user;
initiate, via the wireless data channel, presentation of the payment disbursement plan for display on the user device;
receive a user input to adjust the percentage allocation of the amount from the one or more financial institution accounts of the user, wherein adjusting further comprises adjusting a current weight of one or more holdings associated with the one or more financial institution accounts of the user;
receive a user confirmation to execute the determined the payment disbursement plan;
initiate an execution of the payment disbursement plan;
calculate a new amount of spendable funds or a new estimated amount of time associated with an availability of the amount of funds associated with the user's assets; and
dynamically re-configure the spend user interface based on at least calculating the new amount of spendable funds or estimated amount of time associated with an availability of amount of funds associated with the user's assets, wherein re-configuring further comprises manipulating the graphical interactive visual components to communicate the new amount of spendable funds or estimated amount of time associated with an availability of amount of funds associated with the user's assets;
initiate, via the wireless data channel, presentation of an updated spend user interface to the user, wherein the updated spend user interface is provided on the user device and comprises the new amount of spendable funds or the new estimated amount of time, one or more of the financial institution accounts used to cover the one or more payment options, and an amount from one or more of the financial institution accounts.

9. The computer program product of claim 8, wherein the first apparatus is further configured to cause a processor to determine whether the user is at least one of ahead of a plan, on plan, or behind plan based on at least the amount of outgoing funds, the amount of incoming funds, and the amount of spendable funds;
wherein the user is ahead of a plan when the combination of the amount of outgoing funds and the amount of spendable funds is less than the amount incoming funds;
wherein the user is on plan when the combination of the amount of outgoing funds and the amount of spendable funds is equal to the amount of incoming funds; and
wherein the user is behind plan when the combination of the amount of outgoing funds and the amount of spendable funds is greater than the amount of incoming funds.

10. The computer program product of claim 8, wherein the first apparatus is further configured to cause a processor to:
receive a user input related to the estimated amount of time associated with an availability of the amount of funds associated with the user's assets; and
calculate a new amount of spendable funds based on at least the received estimated amount of time associated with the availability of funds associated with the user's assets.

11. The computer program product of claim 8, wherein the first apparatus is further configured to cause a processor to:
receive a user input related to the amount of spendable funds; and
calculate a new estimated amount of time associated with an availability of the amount of funds associated with the user's assets based on at least the received amount of spendable funds.

12. The computer program product of claim 8, wherein the first apparatus is further configured to cause a processor to:
receive a user input to customize a financial event that could occur for the user, wherein customizing the financial event further comprises receiving, via the spend user interface, one or more additional information associated with the financial event selected by the user;
receive event information associated with the customized financial event that could occur for the user;
access the distributed network of servers to determine the customized financial event costs based on the customized financial event information, or receive a cost input from the user; and
determine one or more payment options from the financial institution accounts for the customized financial event selected by the user based on at least the amount of funds associated with the user's assets, rates of return of the financial accounts, and minimizing any penalties associated with using the funds associated with the user's assets.

13. (canceled)

14. A computer implemented method for assessing impact of financial events on retirement planning for a user, the method comprising:
establishing a communication link with financial accounts of the user, wherein establishing the communication link further comprises establishing an independent communication link with each financial account of the user;
receiving, using a computing device processor, information associated with financial institution accounts of the user from a distributed network of servers, wherein the information comprises an amount of funds associated with the user's assets, an amount of outgoing funds of the user, and an amount of incoming funds of the user;
calculating, using a computing device processor, an amount of spendable funds associated with the user for a time period, wherein the amount of spendable funds is calculated based on the amount of funds associated with the user's assets, the amount of outgoing funds, and the amount of incoming funds for the time period;
calculating, using a computing device processor, an estimated amount of time associated with an availability of the amount of funds associated with the user's assets based on at least the amount of spendable funds and the amount of funds associated with the user's assets;
dynamically configuring a spend user interface comprising interactive graphical visual components to reflect the calculated estimated amount of time associated with the availability of the amount of funds associated with the user's assets, wherein configuring further comprises generating graphical interactive visual components capable of visually communicating an impact of events affecting the calculated estimated amount of time associated with the availability of the amount of funds associated with the user's assets;
establishing a communication link with a user device associated with the user, wherein establishing the communication link creates a wireless data channel with the user device;
initiating, using a computing device processor, presentation of a spend user interface to the user, wherein the spend user interface is provided on a user device and comprises at least the amount of spendable funds associated with the user, the estimated amount of time associated with the availability of the amount of funds associated with the user's assets, and selectable financial event options for one or more financial events, wherein the selectable options comprise the one or more financial events that could occur for the user;
receiving, via the spend user interface, a user selection of a financial event from the one or more financial events, wherein the financial event selected by the user results in an unexpected income and/or an unexpected expense for the user;
initiating, using a computing device processor, presentation of an event information user interface to the user, wherein the event information user interface is provided on the user device and comprises at least selectable options associated with the financial event selected by the user and enables the user to input financial event information associated with the financial event selected by the user, wherein the event information comprises one or more predetermined questions to be presented to the user, the predetermined questions associated with the financial event selected by the user;
receiving, via the event information user interface, the financial event information associated with the financial event selected by the user, wherein receiving the financial event information comprises receiving a response to the one or more predetermined questions from the user;
accessing, using a computing device processor, the distributed network of servers to determine financial event costs based on the financial event information, wherein the financial event costs comprises an estimated amount of funds associated with the unexpected income and/or the unexpected expense;
determining, using a computing device processor, one or more payment options from the financial institution accounts for the financial event selected by the user based on at least the amount of funds associated with the user's assets;
initiating, using a computing device processor, presentation of a payment option user interface to the user, wherein the payment option user interface is provided on the user device and comprises the one or more payment options for the financial event;
receiving, via the payment option user interface, a user selection of at least one of the one or more payment options based on at least a user selection of the one or more payment options;
determining, using a computing device processor, a payment disbursement plan to enable the user to pay for the one or more financial events based on at least the user selection of at least one of the one or more payment options, wherein the disbursement plan comprises a percentage allocation of amounts from the one or more financial institution accounts of the user to be applied towards the one or more financial events selected by the user;
initiating, using a computing device processor, presentation of the payment disbursement plan for display on the user device;
receiving, using a computing device processor, a user input to adjust the percentage allocation of the amount from the one or more financial institution accounts of the user, wherein adjusting further comprises adjusting a current weight of one or more holdings associated with the one or more financial institution accounts of the user;
receiving, using a computing device processor, a user confirmation to execute the determined the payment disbursement plan;
initiating, using a computing device processor, an execution of the payment disbursement plan;
calculating, using a computing device processor, a new amount of spendable funds or a new estimated amount of time associated with an availability of the amount of funds associated with the user's assets; and
dynamically re-configuring the spend user interface based on at least calculating the new amount of spendable funds or estimated amount of time associated with an availability of amount of funds associated with the user's assets, wherein re-configuring further comprises manipulating the graphical interactive visual components to communicate the new amount of spendable funds or estimated amount of time associated with an availability of amount of funds associated with the user's assets;
initiating, using a computing device processor, presentation of an updated spend user interface to the user, wherein the updated spend user interface is provided on the user device and comprises the new amount of spendable funds or the new estimated amount of time, one or more of the financial institution accounts used to cover the one or more payment options, and an amount from one or more of the financial institution accounts.

15. The method of claim 14, wherein determining further comprises determining, using a computing device processor, whether the user is at least one of ahead of a plan, on plan, or behind plan based on at least the amount of outgoing funds, the amount of incoming funds, and the amount of spendable funds;
wherein the user is ahead of a plan when the combination of the amount of outgoing funds and the amount of spendable funds is less than the amount incoming funds;
wherein the user is on plan when the combination of the amount of outgoing funds and the amount of spendable funds is equal to the amount of incoming funds; and
wherein the user is behind plan when the combination of the amount of outgoing funds and the amount of spendable funds is greater than the amount of incoming funds.

16. The method of claim 14, wherein calculating further comprises:
receiving, using a computing device processor, a user input related to the estimated amount of time associated with an availability of the amount of funds associated with the user's assets; and
calculating, using a computing device processor, a new amount of spendable funds based on at least the received estimated amount of time associated with the availability of funds associated with the user's assets.

17. The method of claim 14, wherein calculating further comprises:
receiving a user input related to the amount of spendable funds; and
calculating a new estimated amount of time associated with an availability of the amount of funds associated with the user's assets based on at least the received amount of spendable funds.

18. The method of claim 14, wherein determining further comprises:
receiving a user input to customize a financial event that could occur for the user, wherein customizing the financial event further comprises receiving, via the spend user interface, one or more additional information associated with the financial event selected by the user;
receiving event information associated with the customized financial event that could occur for the user;
accessing the distributed network of servers to determine the customized financial event costs based on the customized financial event information, or receive a cost input from the user; and
determining one or more payment options from the financial institution accounts for the customized financial event selected by the user based on at least the amount of funds associated with the user's assets, rates of return of the financial accounts, and minimizing any penalties associated with using the funds associated with the user's assets.

19. (canceled)

20. (canceled)
